(19) United States
(12) Patent Application Publication
(10) Pub. No.: US 2026/0016878 A1
(43) Pub. Date: Jan. 15, 2026

(54) STAGGERED EXECUTION FOR PEAK POWER MANAGEMENT

(71) Applicant: Micron Technology, Inc., Boise, ID (US)

(72) Inventors: Maria Luisa Gallese, Avezzano (IT); Ali Mohammadzadeh, Mountain View, CA (US); Walter Di Francesco, Avezzano (IT); Biagio Iorio, Luco dei Marsi (IT); Jeremy Binfet, Boise, ID (US); Stefano Di Vito, Avezzano (IT); Liang Yu, Boise, ID (US); Luca Nubile, Sulmona (IT)

(21) Appl. No.: 19/248,899

(22) Filed: Jun. 25, 2025

Related U.S. Application Data
(60) Provisional application No. 63/669,028, filed on Jul. 9, 2024.

(51) Int. Cl. G06F 1/3234; G06F 1/3225; G06F 1/329

(52) U.S. Cl. CPC G06F 1/3275; G06F 1/3225; G06F 1/329

(57) ABSTRACT

A memory die includes a memory array and control logic, operatively coupled with the memory array, to perform operations including initiating, at a first time, a first sub-operation of a first memory access operation on a first memory die of multiple memory dies, where the first sub-operation includes a first high current phase having a first duration. At the first time, a time counter is initiated. At a second time prior to completion of the first high current phase, a request to execute a second sub-operation of a second memory access operation on a second memory die of the plurality of memory dies is identified. At a third time when the time counter equals the first duration, the second sub-operation of the second memory access operation on the second memory die is initiated, where a total current used during concurrent execution of the first sub-operation and the second sub-operation is less than a current budget.

### CROSS-REFERENCE TO RELATED APPLICATION

This application claims the benefit of U.S. Provisional Application No. 63/669,028, titled “Staggered Phase Execution for Peak Power Management”, filed Jul. 9, 2024, which is hereby incorporated herein by reference in its entirety.

### TECHNICAL FIELD

Embodiments of the disclosure relate generally to memory sub-systems, and more specifically, relate to staggered execution of a memory access operation in a memory device implementing peak power management (PPM).

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1A illustrates an example computing system that includes a memory sub-system in accordance with some embodiments of the present disclosure.

FIG. 1B is a block diagram of a memory device in communication with a memory sub-system controller of a memory sub-system in accordance with some embodiments of the present disclosure.

FIGS. 2A-2C are diagrams of portions of an example array of memory cells included in a memory device, in accordance with some embodiments of the present disclosure.

FIG. 3 is a block diagram illustrating a multi-die package with multiple memory dies in a memory sub-system, in accordance with some embodiments of the present disclosure.

FIG. 4 illustrates example waveform approximations of a first multi-phase sub-operation and a second multi-phase sub-operation executed with a staggered start process in a memory sub-system implementing peak power management, according to one or more embodiments of the present disclosure.

FIG. 5 illustrates example waveforms representing current consumption during the execution of staggered sub-operations (i.e., a first sub-operation and a second sub-operation) associated with peak power management of a multi-die memory device of a memory sub-system, according to one or more embodiments of the present disclosure.

FIG. 6 is a flow diagram of a method to stagger execution of multiple sub-operations of multiple memory access operations associated with multiple memory dies of a memory sub-system implementing peak power management, according to one or more embodiments of the present disclosure.

FIG. 7 is a block diagram of an example computer system in which embodiments of the present disclosure may operate.

### DETAILED DESCRIPTION

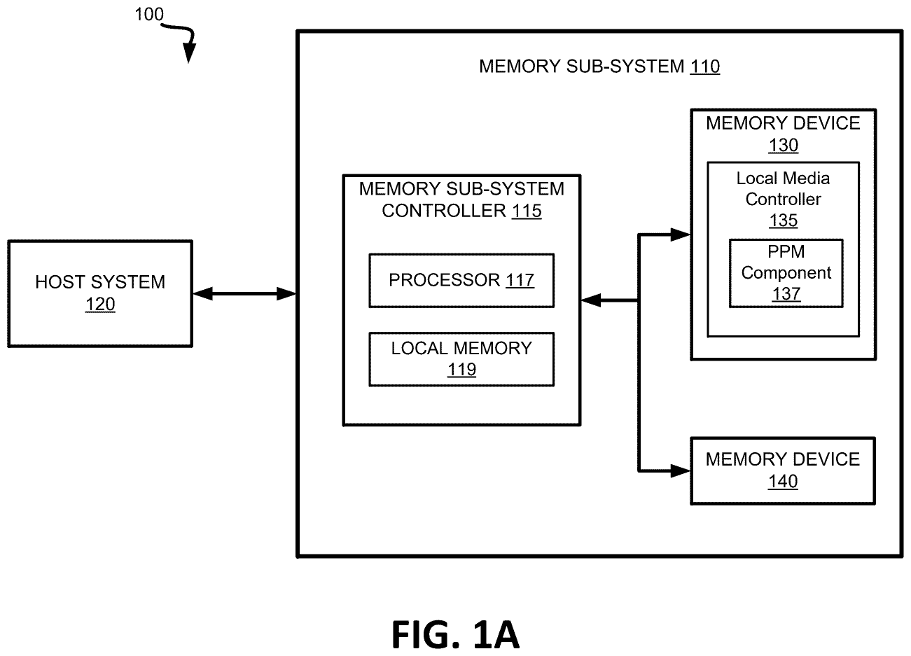

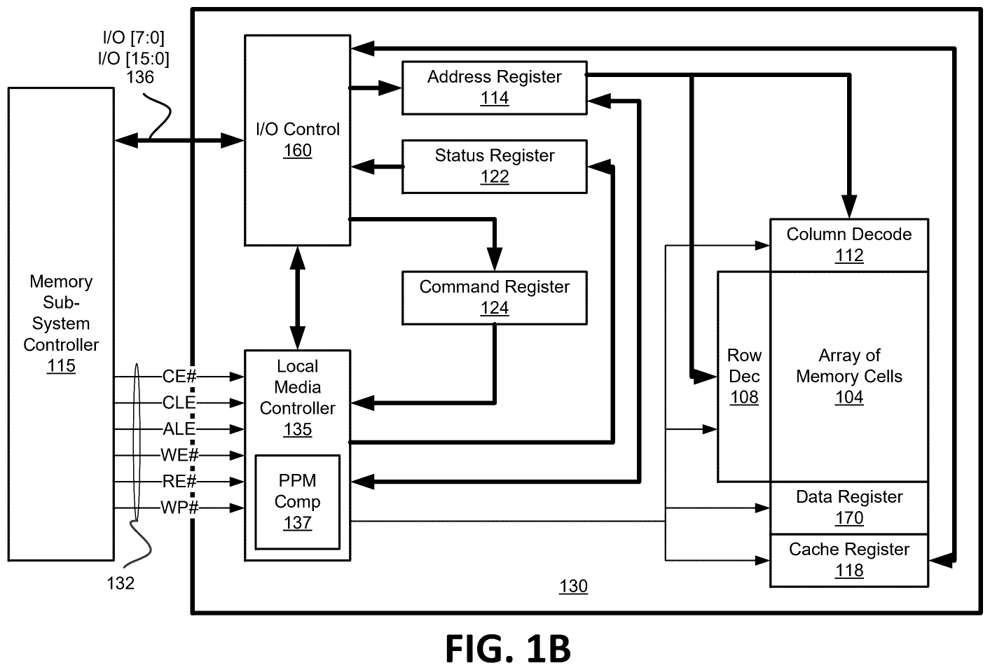

Aspects of the present disclosure are directed to executing staggered portions of a memory access operation in a memory device implementing peak power management (PPM). A memory sub-system can be a storage device, a memory module, or a combination of a storage device and memory module. Examples of storage devices and memory modules are described below in conjunction with FIGS. 1A-1B. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a negative-and (NAND) memory device. Other examples of non-volatile memory devices are described below in conjunction with FIGS. 1A-1B. A non-volatile memory device is a package of one or more dies. Each die can consist of one or more planes. For some types of non-volatile memory devices (e.g., NAND devices), each plane consists of a set of physical blocks. Each block consists of a set of pages. Each page consists of a set of memory cells. A memory cell is an electronic circuit that stores information. Depending on the memory cell type, a memory cell can store one or more bits of binary information, and has various logic states that correlate to the number of bits being stored. The logic states can be represented by binary values, such as “0” and “1”, or combinations of such values.

A memory device can include multiple memory cells arranged in a two-dimensional or three-dimensional grid. The memory cells are formed onto a silicon wafer in an array of columns (also hereinafter referred to as bitlines) and rows (also hereinafter referred to as wordlines). A wordline can refer to one or more conductive lines of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form a plane of the memory device in order to allow concurrent operations to take place on each plane. The memory device can include circuitry that performs concurrent memory page accesses of two or more memory planes. For example, the memory device can include a respective access line driver circuit and power circuit for each plane of the memory device to facilitate concurrent access of pages of two or more memory planes, including different page types. For ease of description, these circuits can be generally referred to as independent plane driver circuits. Control logic on the memory device includes a number of separate processing threads to perform concurrent memory access operations (e.g., read operations, program operations, and erase operations). For example, each processing thread corresponds to a respective one of the memory planes and utilizes the associated independent plane driver circuits to perform the memory access operations on the respective memory plane. As these processing threads operate independently, the power usage and requirements associated with each processing thread also varies.

A memory device can be a three-dimensional (3D) memory device. For example, a 3D memory device can be a three-dimensional (3D) replacement gate memory device (e.g., 3D replacement gate NAND), which is a memory device with a replacement gate structure using wordline stacking. For example, a 3D replacement gate memory device can include wordlines, select gates, etc. located between sets of layers including a pillar (e.g., polysilicon pillar), a tunnel oxide layer, a charge trap (CT) layer, and a dielectric (e.g., oxide) layer. A 3D replacement gate memory device can have a “top deck” corresponding to a first side and a “bottom deck” corresponding to a second side. For example, the first side can be a drain side and the second side can be a source side. Data in a 3D replacement gate memory device can be stored as 1 bit/memory cell (SLC), 2 bits/memory cell (MLC), 3 bits/memory cell (TLC), etc.

Various access lines, data lines and voltage nodes can be charged or discharged very quickly during sense (e.g., read or verify), program, and erase operations so that memory array access operations can meet the performance specifications that are often required to satisfy data throughput targets as might be dictated by customer requirements or industry standards, for example. For sequential read or programming, multi-plane operations are often used to increase the system throughput. As a result, a memory device can have a high peak current usage, which might be four to five times the average current amplitude. Thus, with such a high average market requirement of total current usage budget, it can become challenging to concurrently operate more than a certain number of memory dies (“dies”) of a memory sub-system.

A variety of techniques have been utilized to manage power consumption of memory sub-systems containing multiple memory devices, many of which rely on a memory sub-system controller to control the activity of the memory devices seeking to avoid performing high power portions of access operations concurrently in more than one memory device. For example, in a memory package including multiple memory devices (e.g., multiple separate dies), there can be a peak power management (PPM) system, where each memory device can include a PPM component configured to perform power or current budget arbitration for the respective memory device. For example, each PPM component can implement predictive PPM to perform predictive power budget arbitration for the respective memory device.

In some instances, a PPM system can implement a PPM communication protocol, which is an inter-die communication protocol that can be used for limiting and/or tracking current or power consumed by each memory die. Each memory die can include a PPM component that exchanges information with its own local media controller (e.g., NAND controller) and other PPM components of the other dies via a communication bus. Each PPM component can be configured to perform power or current budget arbitration for the respective memory die. For example, each PPM component can implement predictive PPM to perform predictive power budget arbitration for the respective memory device.

A memory access operation (e.g., program operation, read operation or erase operation) can include multiple sub-operations arranged in an execution sequence. For example, the sub-operations can include an initial sub-operation to initiate the memory access operation, a final sub-operation to complete the memory access operation. The sub-operations can further include at least one intermediate sub-operation performed between the initial sub-operation and the final sub-operation. For each sub-operation, the local media controller can determine whether there is sufficient available current budget to proceed with execution of the sub-operation.

Certain sub-operations, such as the seed-inhibit sub-operation, cannot be divided and must be grouped and executed as a single sub-operation. Accordingly, this sub-operation includes a first peak power event associated with the “seed” phase and a second peak power event associated with the “inhibit” phase. These types of sub-operations are arranged as single execution or non-separable to prevent long waiting times associated with the second peak power event (e.g., a peak power event associated with the “inhibit” phase of the seed-inhibit sub-operation) in instances where an available peak power budget is insufficient.

For example, a seed-inhibit sub-operation associated with a first memory die of a set of memory dies may include a current consumption model including a sequence of a first high current (HC), a first low current (LC), a second HC, and a second LC (e.g., a sequence of HC-LC-HC-LC). During this sequence, the request associated with the first LC results in a release of power budget that becomes available to the remaining memory dies in the set of memory dies. The release of power budget, and resulting utilization by another memory die (e.g., a second memory die), causes a delay in the execution of the second HC of the seed-inhibit sub-operation associated with the second memory die. An undesirable forced delay in executing the second HC of the seed-inhibit sub-operation results, as the first memory die waits for new and sufficient budget to become available. Furthermore, the delay in completion of the seed-inhibit sub-operation of a program operation leads to longer programming times.

In some memory sub-systems, execution of multiple concurrent seed-inhibit sub-operations on different memory die (e.g., a first memory die and a second memory die) leads to the consumption of current (e.g., a needed budget) that exceeds the available budget, an example approach to PPM includes performing the two seed-inhibit sub-operations in series. In this approach, the first seed-inhibit sub-operation is completed on the first memory die before initiating the second seed-inhibit sub-operation on the second memory die. However, this approach results in a waste of budget, since additional available budget is unused during execution of the first seed-inhibit sub-operation. In addition, waiting until the first seed-inhibit sub-operation completes before initiating and performing the second seed-inhibit sub-operation leads to a longer total time to complete both sub-operations.

Aspects of the present disclosure address the above and other deficiencies by implementing peak power management (PPM) including employing staggered execution of phases of multiple sub-operations of multiple memory access operations performed on multiple memory devices (e.g., multiple separate memory dies) of a memory sub-system. Embodiments described herein can generate a rectangular approximation or waveform (also referred to as a “sub-operation waveform”) representing a sub-operation of a memory access operation (e.g., a seed-inhibit sub-operation of a program operation), where the sub-operation includes consecutive high current (HC) and low current (LC) phases repeated in sequence. In an embodiment, each sub-operation waveform approximating the current consumption profile of the sub-operation is defined by a series of current amplitudes (Ai) having a respective duration (Ti). In an embodiment, a parameter set including the current amplitudes and respective durations defining each sub-operation waveform is stored (e.g., as a trim value) and available to all PPMs (e.g., the PPM of each memory die) in the memory sub-system.

In an embodiment, a first request to execute a first sub-operation on a first memory die is identified. In response to the request, execution of first sub-operation is initiated by sending a first command on a bus shared by the multiple PPM. In an embodiment, during execution of the first sub-operation, a second request to initiate a second sub-operation on a second memory die is received. In an embodiment, since the PPM associated with the second memory die is aware of the ongoing first sub-operation, that PPM can determine an available power budget (e.g., an amount of available current), determine an amount of current needed for a first portion of the second sub-operation, and determine a delayed start time for the second sub-operation.

Advantages of the present disclosure include, but are not limited to, improved memory sub-system performance and quality of service (QOS). For example, by staggering the start of a second sub-operation relative to an ongoing first sub-operation, portions of the first sub-operation and the second sub-operation can be executed concurrently, while the total combined budget used or consumed by the first sub-operation and the second sub-operation does not exceed a maximum available budget. This results in the performance of PPM while executing concurrent staggered sub-operations to optimize usage of available budget, without exceeding the maximum current budget.

FIG. 1A illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1A illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, a compute express link (CXL) controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a CXL interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., the one or more memory device(s) 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1A illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a negative-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level memory cells (SLC) can store one bit per memory cell. Other types of memory cells, such as multi-level memory cells (MLCs), triple level memory cells (TLCs), quad-level memory cells (QLCs), and penta-level memory cells (PLCs) can store multiple bits per memory cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local controller 135) on the die and a controller (e.g., memory sub-system controller 115) for media management within the same memory device package. An example of a managed memory device is a managed NAND (MNAND) device.

The local media controller 135 can utilize scheduled interrupts for token ring communication during PPM. In such an embodiment, PPM component 137 can be implemented using hardware or as firmware, stored on memory device 130, executed by the control logic (e.g., local media controller 135) to perform the operations related to performing a memory access operation during PPM as described herein. In some embodiments, the memory sub-system controller 115 includes at least a portion of PPM component 137. For example, the memory sub-system controller 115 can include a processor 117 (e.g., a processing device) configured to execute instructions stored in local memory 119 for performing the operations described herein.

To implement staggered sub-operations (e.g., staggering multiple seed-inhibit sub-operations of multiple program operations) during PPM, local media controller 135 can initialize PPM with staggered execution. For example, the local media controller can initialize PPM with staggered execution with respect to a PPM network of the memory sub-system 110 after power up of the memory sub-system 110. The PPM network can include multiple memory dies forming a PPM group. The group may include an ordered group of memory dies.

Initializing PPM can include initializing a set of PPM parameters. The set of PPM parameters include a number of parameters defining the operation of PPM within the PPM network. The parameters may include a waveform approximation for each sub-operation. In an embodiment, a current consumption profile representing each sub-operation is approximated using a respective rectangular shape for each phase of the sub-operation. For example, a first phase of the sub-operation (e.g., a first high current (HC) phase of the sub-operation) may be approximated by a first rectangular shape having a first current amplitude (A1) and a first duration (T1). In this example, a second phase of the sub-operation (e.g., a first low current (LC) phase of the sub-operation) may be approximated by a second rectangular shape having a second current amplitude (A1) and a second duration (T2). In this example, a third phase of the sub-operation (e.g., a second high current (HC) phase of the sub-operation) may be approximated by a third rectangular shape having a third current amplitude (A3) and a third duration (T3). In this is example, a fourth phase of the sub-operation (e.g., a second low current (LC) phase of the sub-operation) may be approximated by a fourth rectangular shape having a fourth current amplitude (A4) and a fourth duration (T4). This set of parameters defining the waveform approximation of the sub-operation may be stored as values (e.g., trim values) in a memory associated with the local media controller 135 which is accessible by the PPM component 137.

In an embodiment, the set of PPM parameters can further include a current budget (e.g., a maximum current budget), the number of memory dies of the PPM group, a size of data packets communicated by each memory die of the PPM group during a PPM cycle, a configuration of the position of each memory die within the PPM group (i.e., to define the order of the memory dies within the PPM group), etc. According to embodiments, PPM component 137 can receive a first request to execute a first sub-operation on a first memory die. In response to the request, the PPM component 137 can initiate execution of the first sub-operation sending a first command on a bus shared by the multiple PPM components 137 associated with the multiple memory dies of the memory sub-system 110. In an embodiment, during execution of the first sub-operation, the PPM component 137 may receive a second request to initiate a second sub-operation on a second memory die. In an embodiment, since the PPM component 137 is aware of the ongoing first sub-operation, that PPM component 137 can determine an available power budget (e.g., an amount of available current), determine an amount of current needed for a first portion of the second sub-operation, and determine a delayed start time for the second sub-operation.

In an embodiment, after the delay (i.e., at the identified delayed start time), the PPM component 137 can initiate execution of the “staggered” second sub-operation on the second memory device. In an embodiment, the PPM component 137 delays the start of the second sub-operation until a first HC phase of the first sub-operation is completed. Advantageously, a first HC phase of the second sub-operation is performed concurrently with a first LC phase of the first sub-operation, such that the total current used by the two sub-operations does not exceed the maximum available budget. Further details regarding the staggered execution of multiple sub-operations during PPM are described below with reference to FIGS. 1B-7.

FIG. 1B is a simplified block diagram of a first apparatus, in the form of a memory device 130, in communication with a second apparatus, in the form of a memory sub-system controller 115 of a memory sub-system (e.g., memory sub-system 110 of FIG. 1A), according to an embodiment. Some examples of electronic systems include personal computers, personal digital assistants (PDAs), digital cameras, digital media players, digital recorders, games, appliances, vehicles, wireless devices, mobile telephones and the like. The memory sub-system controller 115 (e.g., a controller external to the memory device 130), may be a memory controller or other external host device.

Memory device 130 includes an array of memory cells 104 logically arranged in rows and columns. Memory cells of a logical row are typically connected to the same access line (e.g., a wordline) while memory cells of a logical column are typically selectively connected to the same data line (e.g., a bitline). A single access line may be associated with more than one logical row of memory cells and a single data line may be associated with more than one logical column. Memory cells (not shown in FIG. 1B) of at least a portion of array of memory cells 104 are capable of being programmed to one of at least two target data states.

Row decode circuitry 108 and column decode circuitry 112 are provided to decode address signals. Address signals are received and decoded to access the array of memory cells 104. Memory device 130 also includes input/output (I/O) control circuitry 160 to manage input of commands, addresses and data to the memory device 130 as well as output of data and status information from the memory device 130. An address register 114 is in communication with I/O control circuitry 160 and row decode circuitry 108 and column decode circuitry 112 to latch the address signals prior to decoding. A command register 124 is in communication with I/O control circuitry 160 and local media controller 135 to latch incoming commands.

A controller (e.g., the local media controller 135 internal to the memory device 130) controls access to the array of memory cells 104 in response to the commands and generates status information for the external memory sub-system controller 115, i.e., the local media controller 135 is configured to perform access operations (e.g., read operations, programming operations and/or erase operations) on the array of memory cells 104. The local media controller 135 is in communication with row decode circuitry 108 and column decode circuitry 112 to control the row decode circuitry 108 and column decode circuitry 112 in response to the addresses. In one embodiment, local media controller 135 includes the PPM component 137, which can implement PPM using staggered execution of multiple sub-operations of multiple memory access operations, where current consumption associated with each sub-operation is approximated by a waveform representing the sequence of HC phases and LC phases.

The local media controller 135 is also in communication with a cache register 118. Cache register 118 latches data, either incoming or outgoing, as directed by the local media controller 135 to temporarily store data while the array of memory cells 104 is busy writing or reading, respectively, other data. During a program operation (e.g., write operation), data may be passed from the cache register 118 to the data register 170 for transfer to the array of memory cells 104; then new data may be latched in the cache register 118 from the I/O control circuitry 160. During a read operation, data may be passed from the cache register 118 to the I/O control circuitry 160 for output to the memory sub-system controller 115; then new data may be passed from the data register 170 to the cache register 118. The cache register 118 and/or the data register 170 may form (e.g., may form a portion of) a page buffer of the memory device 130. A page buffer may further include sensing devices (not shown in FIG. 1B) to sense a data state of a memory cell of the array of memory cells 204, e.g., by sensing a state of a data line connected to that memory cell. A status register 122 may be in communication with I/O control circuitry 160 and the local memory controller 135 to latch the status information for output to the memory sub-system controller 115.

Memory device 130 receives control signals at the memory sub-system controller 115 from the local media controller 135 over a control link 132. For example, the control signals can include a chip enable signal CE #, a command latch enable signal CLE, an address latch enable signal ALE, a write enable signal WE #, a read enable signal RE #, and a write protect signal WP #. Additional or alternative control signals (not shown) may be further received over control link 132 depending upon the nature of the memory device 130. In one embodiment, memory device 130 receives command signals (which represent commands), address signals (which represent addresses), and data signals (which represent data) from the memory sub-system controller 115 over a multiplexed input/output (I/O) bus 136 and outputs data to the memory sub-system controller 115 over I/O bus 136.

For example, the commands may be received over input/output (I/O) pins [7:0] of I/O bus 136 at I/O control circuitry 160 and may then be written into command register 124. The addresses may be received over input/output (I/O) pins [7:0] of I/O bus 136 at I/O control circuitry 160 and may then be written into address register 114. The data may be received over input/output (I/O) pins [7:0] for an 8-bit device or input/output (I/O) pins [15:0] for a 16-bit device at I/O control circuitry 160 and then may be written into cache register 118. The data may be subsequently written into data register 170 for programming the array of memory cells 104.

In an embodiment, cache register 118 may be omitted, and the data may be written directly into data register 170. Data may also be output over input/output (I/O) pins [7:0] for an 8-bit device or input/output (I/O) pins [15:0] for a 16-bit device. Although reference may be made to I/O pins, they may include any conductive node providing for electrical connection to the memory device 130 by an external device (e.g., the memory sub-system controller 115), such as conductive pads or conductive bumps as are commonly used.

It will be appreciated by those skilled in the art that additional circuitry and signals can be provided, and that the memory device 130 of FIGS. 1A-1B has been simplified. It should be recognized that the functionality of the various block components described with reference to FIGS. 1A-1B may not necessarily be segregated to distinct components or component portions of an integrated circuit device. For example, a single component or component portion of an integrated circuit device could be adapted to perform the functionality of more than one block component of FIGS. 1A-1B. Alternatively, one or more components or component portions of an integrated circuit device could be combined to perform the functionality of a single block component of FIGS. 1A-1B. Additionally, while specific I/O pins are described in accordance with popular conventions for receipt and output of the various signals, it is noted that other combinations or numbers of I/O pins (or other I/O node structures) may be used in the various embodiments.

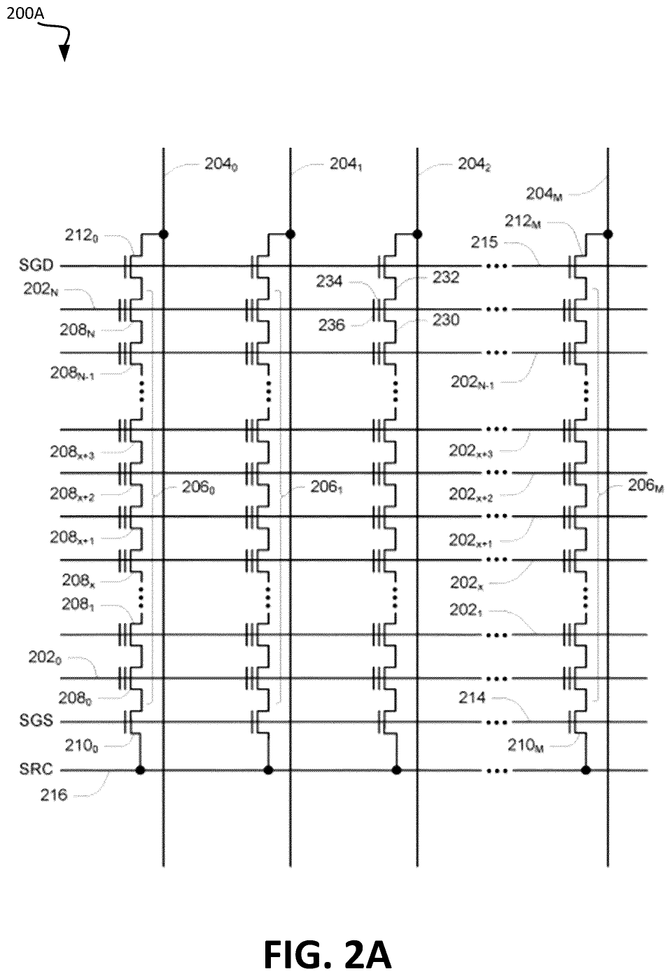

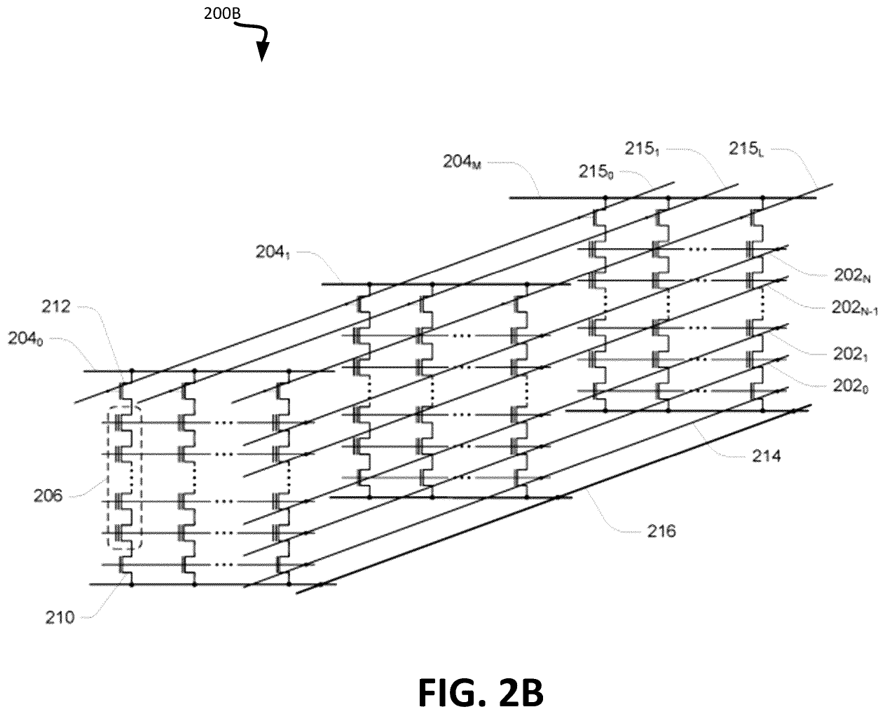

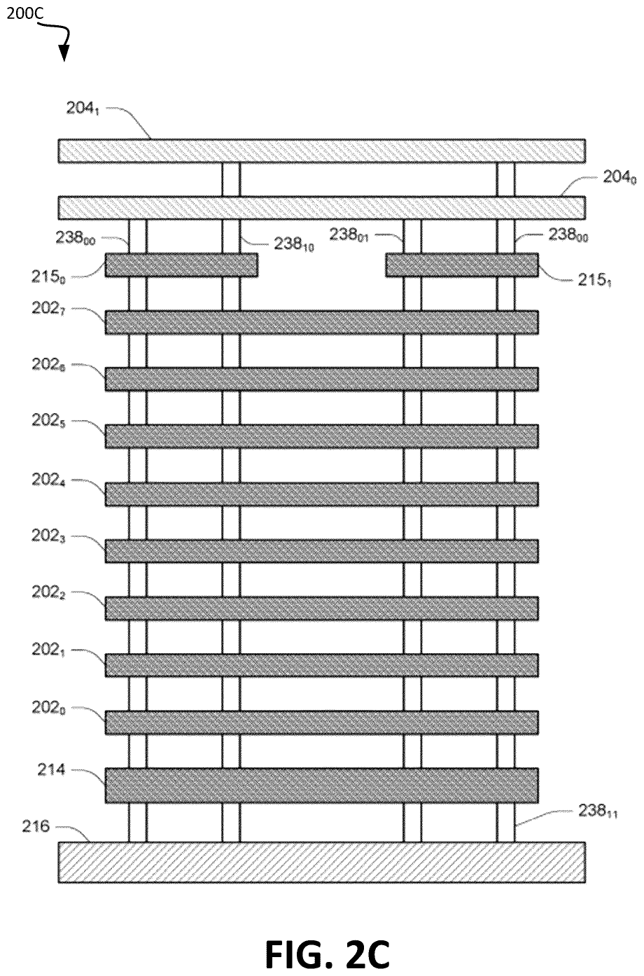

FIGS. 2A-2C are diagrams of portions of an example array of memory cells included in a memory device, in accordance with some embodiments of the present disclosure. For example, FIG. 2A is a schematic of a portion of an array of memory cells 200A as could be used in a memory device (e.g., as a portion of array of memory cells 104). Memory array 200A includes access lines, such as wordlines 202₀ to 202_{N}, and a data line, such as bitline 204. The wordlines 202 may be connected to global access lines (e.g., global wordlines), not shown in FIG. 2A, in a many-to-one relationship. For some embodiments, memory array 200A may be formed over a semiconductor that, for example, may be conductively doped to have a conductivity type, such as a p-type conductivity, e.g., to form a p-well, or an n-type conductivity, e.g., to form an n-well.

Memory array 200A can be arranged in rows each corresponding to a respective wordline 202 and columns each corresponding to a respective bitline 204. Rows of memory cells 208 can be divided into one or more groups of physical pages of memory cells 208, and physical pages of memory cells 208 can include every other memory cell 208 commonly connected to a given wordline 202. For example, memory cells 208 commonly connected to wordline 202_{N} and selectively connected to even bitlines 204 (e.g., bitlines 204₀, 204₂, 204₄, etc.) may be one physical page of memory cells 208 (e.g., even memory cells) while memory cells 208 commonly connected to wordline 202_{N} and selectively connected to odd bitlines 204 (e.g., bitlines 204₁, 204₃, 204₅, etc.) may be another physical page of memory cells 208 (e.g., odd memory cells). Although bitlines 204₃-204₅ are not explicitly depicted in FIG. 2A, it is apparent from the figure that the bitlines 204 of the array of memory cells 200A may be numbered consecutively from bitline 204₀ to bitline 204_{M}. Other groupings of memory cells 208 commonly connected to a given wordline 202 may also define a physical page of memory cells 208. For certain memory devices, all memory cells commonly connected to a given wordline might be deemed a physical page of memory cells. The portion of a physical page of memory cells (which, in some embodiments, could still be the entire row) that is read during a single read operation or programmed during a single programming operation (e.g., an upper or lower page of memory cells) might be deemed a logical page of memory cells. A block of memory cells may include those memory cells that are configured to be erased together, such as all memory cells connected to wordlines 202₀-202_{N} (e.g., all strings 206 sharing common wordlines 202). Unless expressly distinguished, a reference to a page of memory cells herein refers to the memory cells of a logical page of memory cells.

Each column can include a string of series-connected memory cells (e.g., non-volatile memory cells), such as one of strings 206₀ to 206_{M}. Each string 206 can be connected (e.g., selectively connected) to a source line 216 (SRC) and can include memory cells 208₀ to 208_{N}. The memory cells 208 of each string 206 can be connected in series between a select gate 210, such as one of the select gates 210₀ to 210_{M}, and a select gate 212, such as one of the select gates 212₀ to 212_{M}. In some embodiments, the select gates 210₀ to 210_{M} are source-side select gates (SGS) and the select gates 212₀ to 212_{M} are drain-side select gates. Select gates 210₀ to 210_{M} can be connected to a select line 214 (e.g., source-side select line) and select gates 212₀ to 212_{M} can be connected to a select line 215 (e.g., drain-side select line). The select gates 210 and 212 might represent a plurality of select gates connected in series, with each select gate in series configured to receive a same or independent control signal. A source of each select gate 210 can be connected to SRC 216, and a drain of each select gate 210 can be connected to a memory cell 208₀ of the corresponding string 206. Therefore, each select gate 210 can be configured to selectively connect a corresponding string 206 to SRC 216. A control gate of each select gate 210 can be connected to select line 214. The drain of each select gate 212 can be connected to the bitline 204 for the corresponding string 206. The source of each select gate 212 can be connected to a memory cell 208_{N} of the corresponding string 206. Therefore, each select gate 212 might be configured to selectively connect a corresponding string 206 to the bitline 204. A control gate of each select gate 212 can be connected to select line 215.

In some embodiments, and as will be described in further detail below with reference to FIG. 2B, the memory array in FIG. 2A is a three-dimensional memory array, in which the strings 206 extend substantially perpendicular to a plane containing SRC 216 and to a plane containing a plurality of bitlines 204 that can be substantially parallel to the plane containing SRC 216.

FIG. 2B is another schematic of a portion of an array of memory cells 200B (e.g., a portion of the array of memory cells 104) arranged in a three-dimensional memory array structure. The three-dimensional memory array 200B may incorporate vertical structures which may include semiconductor pillars where a portion of a pillar may act as a channel region of the memory cells of strings 206. The strings 206 may be each selectively connected to a bit line 204₀-204_{M} by a select gate 212 and to the SRC 216 by a select gate 210. Multiple strings 206 can be selectively connected to the same bitline 204. Subsets of strings 206 can be connected to their respective bitlines 204 by biasing the select lines 215₀-215_{L} to selectively activate particular select gates 212 each between a string 206 and a bitline 204. The select gates 210 can be activated by biasing the select line 214. Each wordline 202 may be connected to multiple rows of memory cells of the memory array 200B. Rows of memory cells that are commonly connected to each other by a particular wordline 202 may collectively be referred to as tiers.

FIG. 2C is a diagram of a portion of an array of memory cells 200C (e.g., a portion of the array of memory cells 104). Channel regions (e.g., semiconductor pillars) 238₀₀ and 238₀₁ represent the channel regions of different strings of series-connected memory cells (e.g., strings 206 of FIGS. 2A-2B) selectively connected to the bitline 204₀. Similarly, channel regions 238₁₀ and 238₁₁ represent the channel regions of different strings of series-connected memory cells (e.g., NAND strings 206 of FIGS. 2A-2B) selectively connected to the bitline 204₁. A memory cell (not depicted in FIG. 2C) may be formed at each intersection of a wordline 202 and a channel region 238, and the memory cells corresponding to a single channel region 238 may collectively form a string of series-connected memory cells (e.g., a string 206 of FIGS. 2A-2B). Additional features might be common in such structures, such as dummy wordlines, segmented channel regions with interposed conductive regions, etc.

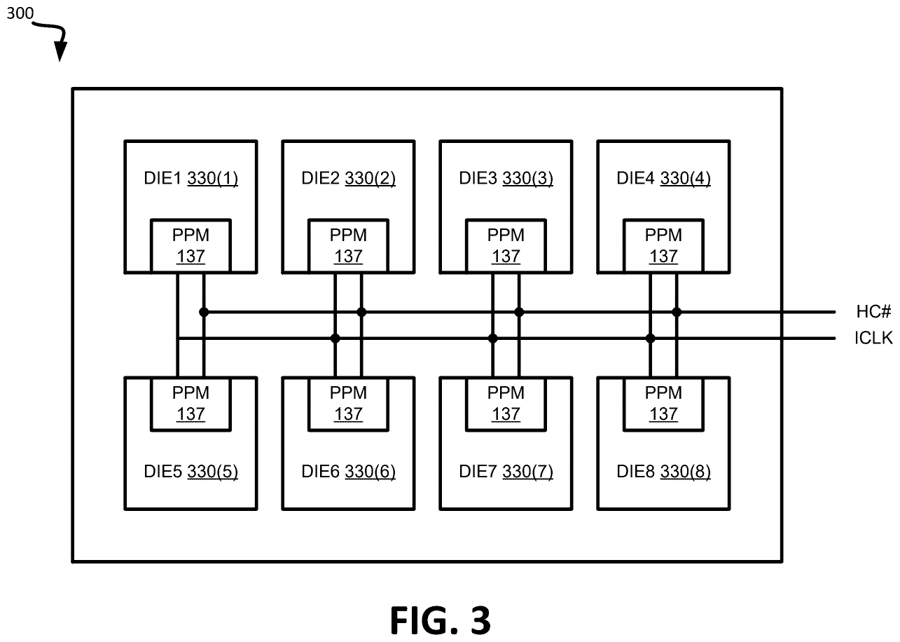

FIG. 3 is a block diagram illustrating a multi-die package 300 with multiple memory dies in a memory sub-system, in accordance with some embodiments of the present disclosure. As illustrated, multi-die package 300 includes memory dies 330(1)-330(8). In other embodiments, however, multi-die package 300 can include some other number of memory dies, such as additional or fewer memory dies. In one embodiment, memory dies 330(1)-330(8) share a clock signal ICLK which is received via a clock signal line. Memory dies 330(1)-330(8) can be selectively enabled in response to a chip enable signal (e.g., via a control link), and can communicate over a separate I/O bus. In an embodiment, a message or signal HC # including PPM information (e.g., a staggered execution signal, a peak current magnitude indicator signal, etc.) is commonly shared between the memory dies 330(1)-330(8). For example, the peak current magnitude indicator signal HC # can be normally pulled to a particular state (e.g., pulled high). In one embodiment, each of memory dies 330(1)-330(8) includes an instance of PPM component 137, which receives both the clock signal ICLK and the signal HC #.

Each PPM component can maintain the information broadcast by each die (e.g., within respective registers), which enables each die to calculate the current consumption. For example, if there are four dies Die 1 through Die 4, each Die 1 through Die 4 can maintain information broadcast by Die 1 through Die 4 within respective registers designated for Die 1 through Die 4. Since each of Die 1 through Die 4 maintains the maximum current budget the most updated current consumption, each of Die 1 through Die 4 can calculate the available current budget. Accordingly, each of Die 1 through Die 4 can determine whether there is a sufficient amount of available current budget for its local media controller to execute a new memory access operation.

According to embodiments, a corresponding PPM component 137 can initiate a first sub-operation associated with a first selected memory die (e.g., Die 1). In an embodiment, the first sub-operation can have a current profile that is approximated using a rectangular waveform, where each phase (e.g., the sequence of HC and LC phases) is approximated by a current amplitude (Ai) and a phase interval (Ti), where i represents a phase number. The phase approximation values (Ai, Ti) are stored as parameters and accessible by the respective PPM components 137 of each of the memory dies (Die 1 through Die 8).

In an embodiment, during execution of the first sub-operation, a request to execute a second sub-operation on a second memory die (e.g., Die 2) is received by the PPM component 137. In response, the PPM component 137 can send a staggered execution signal via the HC # to a common bus associated with all of the PPM components 137. In an embodiment, each PPM component 137 of each memory die can calculate an appropriate current budget associated with each phase of a requested sub-operation.

In an embodiment, the PPM component 137 of the memory die associated with the second sub-operation can identify a staggered start time (e.g., a delay window) for a first phase (e.g., a first HC phase) of the second sub-operation. In an embodiment, the delay window is set such that the start time of the second sub-operation corresponds to an end time of a first HC phase of the ongoing first sub-operation (e.g., at a transition from the first HC phase of the first sub-operation to a first LC phase of the first sub-operation). In this regard, the first HC phase of the second sub-operation is performed concurrently with the first LC phase of the first sub-operation, such that the total current used by the two sub-operations is below the maximum current budget associated with the memory sub-system.

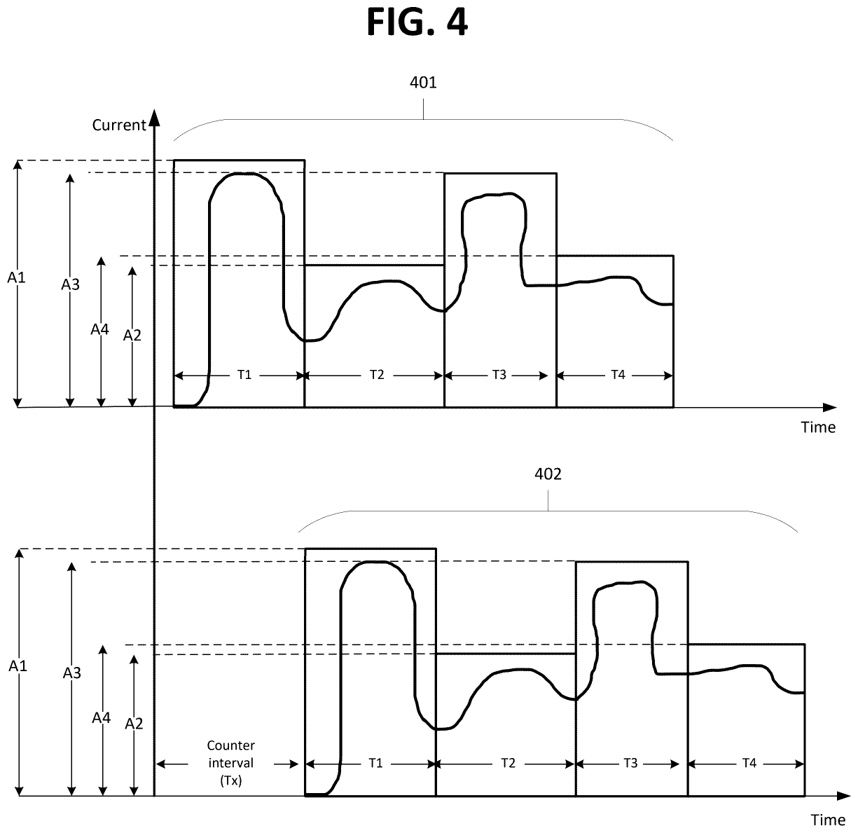

FIG. 4 illustrates an example first waveform approximation of a first multi-phase sub-operation 401 and an example second waveform approximation of a second multi-phase sub-operation 402, according to embodiments of the present disclosure. As shown in FIG. 4, the first waveform 401 includes: a first phase having a first current amplitude (A1) and a first duration (T1); a second phase having a second current amplitude (A2) and a second duration (T2); a third phase having a third current amplitude (A3) and a third duration (T3); and a fourth phase having a fourth current amplitude (A4) and a fourth duration (T4). As illustrated, the first and third phases are HC phases and the second and fourth phases are LC phases of the first multi-phase sub-operation 401.

As illustrate in FIG. 4, like the first multi-phase sub-operation 401, the second waveform representing the second sub-operation 402 includes: a first phase having a first current amplitude (A1) and a first duration (T1); a second phase having a second current amplitude (A2) and a second duration (T2); a third phase having a third current amplitude (A3) and a third duration (T3); and a fourth phase having a fourth current amplitude (A4) and a fourth duration (T4). As illustrated, the first and third phases are HC phases and the second and fourth phases are LC phases of the first multi-phase sub-operation 402.

In the example shown in FIG. 4, at a start of execution of the first sub-operation, a counter (Tx) is initialized. At a time during execution of the first phase of the first sub-operation 401, a request to execute the second sub-operation is received. In an embodiment, the start of the staggered second sub-operation is delayed until the counter reaches a value equal to the duration of the first phase (i.e., when the time counter Tx equals T1). In the example shown in FIG. 4, the start of the second sub-operation is staggered relative to the first sub-operation, such that the first HC phase of the first sub-operation completes and transitions to a second phase (i.e., a first LC phase of the first sub-operation) before initiating the first phase (i.e., the first HC phase) of the second sub-operation. Accordingly, the first phase of the second sub-operation is performed concurrently with a LC phase of the first sub-operation, such that the total current used by the concurrently executed phases does not exceed the maximum available current budget.

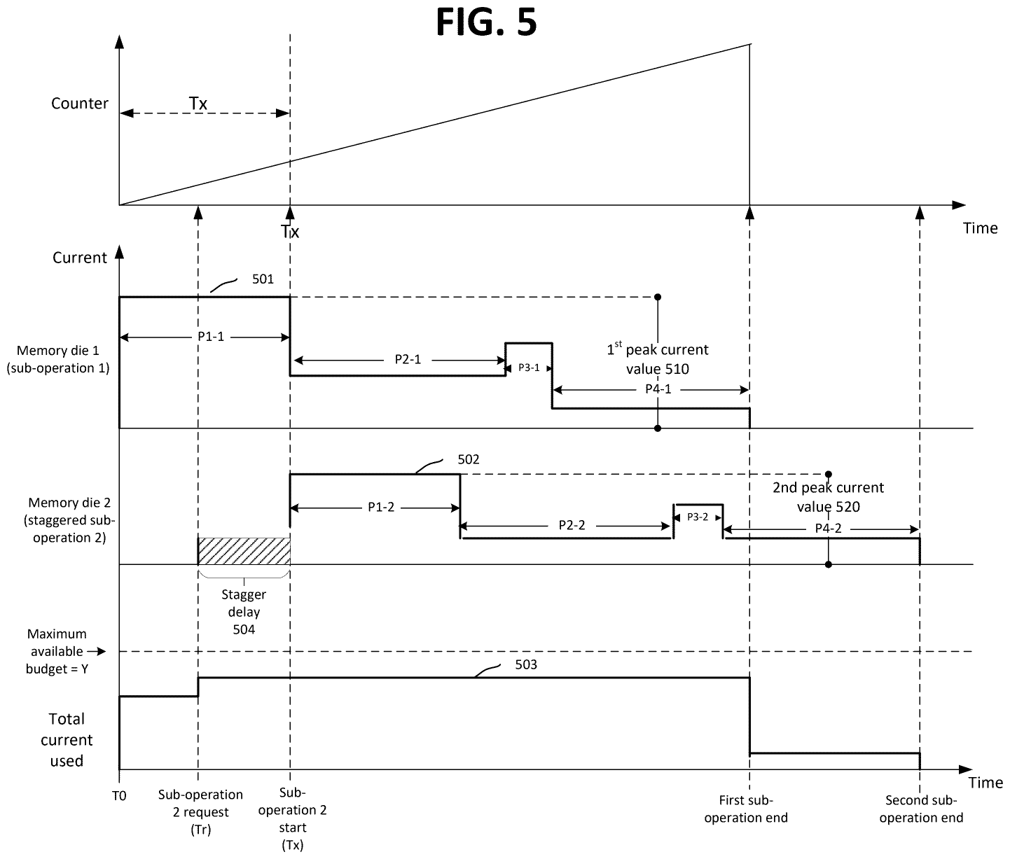

FIG. 5 illustrates example waveforms representing current consumption during the execution of staggered sub-operations (i.e., a first sub-operation and a second sub-operation) associated with PPM of a multi-die memory device of a memory sub-system, according to embodiments of the present disclosure. As shown in FIG. 5, at a first time (TO), a first sub-operation (e.g., a non-divisible sub-operation such as a seed-inhibit sub-operation) of a memory access operation (e.g., a program operation) on a first memory die (Memory die 1) is initiated. As shown in FIG. 5, the first sub-operation 501 includes four phases (P1-1, P2-1, P3-1, and P4-1), where the first phase is an HC phase, the second phase is an LC phase, the third phase is an HC phase, and the fourth phase is an LC phase.

In an embodiment, as shown in FIG. 5, during execution of the first phase (P1) of the first sub-operation associated with memory die 1, at time Tr, a request to execute a second sub-operation associated with memory die 2 which includes four phases (P1-2, P2-2, P3-2, and P4-2). In response to the request, a PPM component initiates a staggered execution of the second sub-operation 502, where the start of the second sub-operation 502 is delayed by the stagger delay 504 (i.e., a duration of time from Tr to Tx). As illustrated, when the tie counter reaches Tx (i.e., the counter reaches the time duration associated with an end of the first HC phase (P1) of the first sub-operation 501), the PPM component starts the first phase (P1-2) of the second sub-operation 502.

Advantageously, as shown, a total current used during the staggered execution of the first sub-operation 501 and the second sub-operation 502 reaches a maximum current consumed 503 which is less than the maximum available budget (Y). This is a result of staggering the execution of the sub-operations such that the HC stages and LC stages of the respective sub-operations are performed concurrently, without the concurrent execution of multiple HC stages.

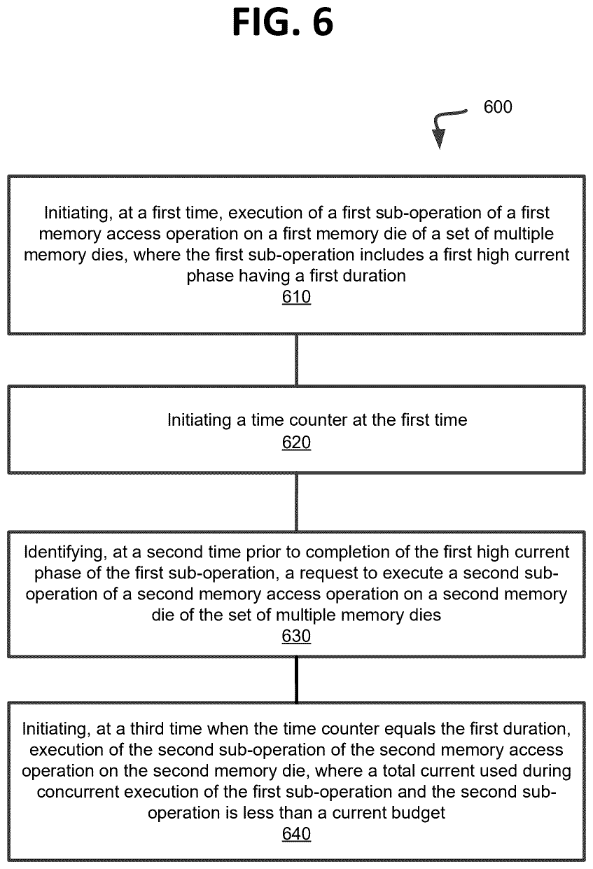

FIG. 6 is a flow diagram of a method 600 to stagger execution of sub-operations of multiple memory access operations associated with multiple memory dies of a memory sub-system implementing PPM, in accordance with some embodiments of the present disclosure. The method 600 can be performed by control logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600 is performed by the local media controller 135 and/or the PPM component 137 of FIGS. 1A-1B. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 610, an operation is initiated. For example, control logic can initiate, at a first time, execution of a first sub-operation of a first memory access operation on a first memory die of a set of multiple memory dies, where the first sub-operation includes a first high current phase having a first duration. In an embodiment, the first sub-operation (e.g., a seed-inhibit sub-operation of a program operation) includes a first sequence of phases including the first high current (HC) phase (e.g., a phase during which a high level of current is consumed), which is followed by a first low current (LC) phase (e.g., a phase during which a low level of current is consumed), which is followed by a second HC phase, which is followed by a second LC phase.

In an embodiment, the current consumption profile associated with the sequence of phases of the first sub-operation may be approximated to generate a rectangular waveform approximation corresponding to each phase. In an embodiment, the rectangular waveform approximation of each phase may be characterized by a set of parameters including a current amplitude (Ai) and a time duration (Ti), where i represents the corresponding phase number. For example, the first phase may be characterized by a first set of parameters (A1, T1), a second phase may be characterized by a second set of parameters (A2, T2), and so on.

At operation 620, a counter is initiated. For example, control logic can initiate a time counter at the first time. In an embodiment, upon initiating execution of the first phase of the first sub-operation, control logic can initiate or start a time counter. The time counter can be used to monitor the progress of the first sub-operation and determine a delay that is needed prior to initiating another sub-operation, as described in greater detail below.

At operation 630, a request is identified. For example, control logic an identify, at a second time prior to completion of the first high current phase of the first sub-operation, a request to execute a second sub-operation of a second memory access operation on a second memory die of the set of memory dies. In an embodiment, the control logic receives the request and determines that the execution of the second sub-operation is to be delayed, in view of the ongoing first sub-operation. In an embodiment, since the first high current phase of the first sub-operation is in progress, executing the second sub-operation without the delay would result in the total current used by the concurrent execution of the first sub-operation and the second sub-operation to exceed a current budget. To avoid this, the control logic delays the start of the sub-operation, as described below with reference to operation 640.

In operation 640, an operation is executed. For example, control logic can initiate, at a third time when the time counter equals the first duration, execution of the second sub-operation of the second memory access operation on the second memory die, where a total current used during concurrent execution of the first sub-operation and the second sub-operation is less than a current budget. In an embodiment, when the time counter reaches the first duration associated with the first high current phase of the first sub-operation, control logic determines that the first high current phase is complete, and that a next phase in the sequence of the first sub-operation is a first low current phase. Accordingly, control logic initiates execution of a first phase of the second sub-operation, which is a high current phase. Advantageously, staggering or delaying the execution of the second sub-operation enables concurrent execution of the first sub-operation and the second sub-operation in a manner in which the total current used does not exceed the current budget (as illustrated in FIG. 5). In an embodiment, the delayed or staggered start of the second sub-operation enables the high current phase of the second sub-operation to be executed during a low current phase of the first sub-operation, such that the total current used during execution of those phases remains below the current budget. Further details regarding operations 610-640 are described above with reference to FIGS. 1A-5.

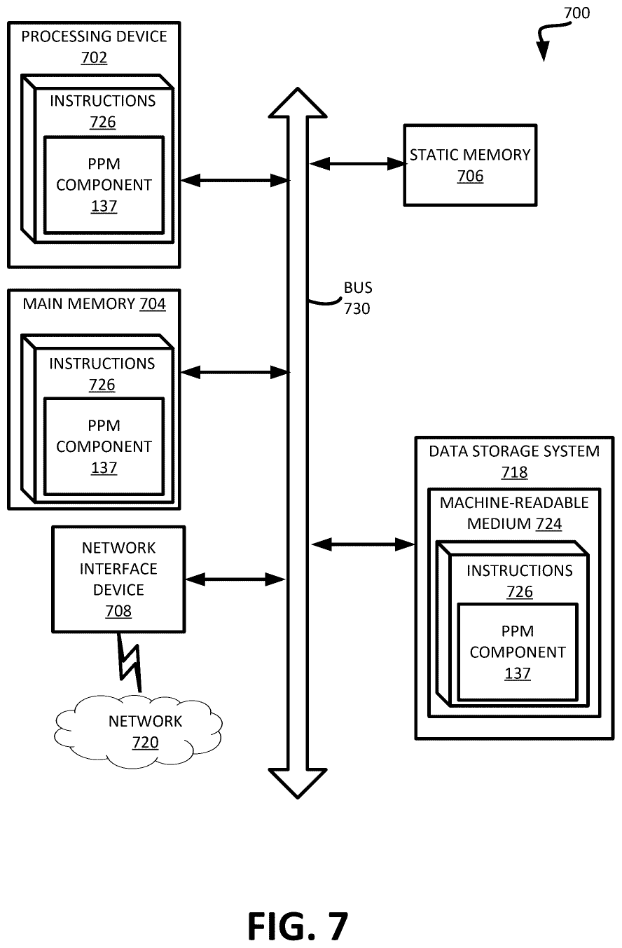

FIG. 7 illustrates an example machine of a computer system 700 within which a set of instructions, for causing the machine to perform any one or more of the methodologies discussed herein, can be executed. In some embodiments, the computer system 700 can correspond to a host system (e.g., the host system 120 of FIG. 1A) that includes, is coupled to, or utilizes a memory sub-system (e.g., the memory sub-system 110 of FIG. 1A) or can be used to perform the operations of a controller (e.g., to execute an operating system to perform operations corresponding to the local media controller 135 and/or the PPM component 137 of FIG. 1A). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a memory cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or RDRAM, etc.), a static memory 706 (e.g., flash memory, static random access memory (SRAM), etc.), and a data storage system 718, which communicate with each other via a bus 730.

Processing device 702 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 can also be one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein. The computer system 700 can further include a network interface device 708 to communicate over the network 720.

The data storage system 718 can include a machine-readable storage medium 724 (also known as a computer-readable medium) on which is stored one or more sets of instructions 726 or software embodying any one or more of the methodologies or functions described herein. The instructions 726 can also reside, completely or at least partially, within the main memory 704 and/or within the processing device 702 during execution thereof by the computer system 700, the main memory 704 and the processing device 702 also constituting machine-readable storage media. The machine-readable storage medium 724, data storage system 718, and/or main memory 704 can correspond to the memory sub-system 110 of FIG. 1A.

In one embodiment, the instructions 726 include instructions to implement functionality corresponding to a local media controller and/or PPM component (e.g., the local media controller 135 and/or the PPM component 137 of FIG. 1A). While the machine-readable storage medium 724 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory device comprising:
a plurality of memory dies, each memory die of the plurality of memory dies comprising:
a memory array; and
control logic, operatively coupled with the memory array, to perform peak power management (PPM) operations comprising:
initiating, at a first time, a first sub-operation of a first memory access operation on a first memory die of the plurality of memory dies, wherein the first sub-operation comprises a first high current phase having a first duration;
initiating a time counter at the first time;
identifying, at a second time prior to completion of the first high current phase, a request to execute a second sub-operation of a second memory access operation on a second memory die of the plurality of memory dies; and
initiating, at a third time when the time counter equals the first duration, the second sub-operation of the second memory access operation on the second memory die, wherein a total current used during concurrent execution of the first sub-operation and the second sub-operation is less than a current budget.

2. The memory device of claim 1, wherein the first sub-operation comprises a first sequence of phases comprising the first high current phase followed by a first low current phase.

3. The memory device of claim 2, wherein the second sub-operation comprises a second sequence of phases comprising an initial high current phase.

4. The memory device of claim 3, wherein the initial high current phase of the second sub-operation is executed concurrently with the first low current phase of the first sub-operation.

5. The memory device of claim 2, wherein each phase of the first sequence of phases is approximated by a rectangular waveform comprising a current amplitude parameter and a time duration parameter.

6. The memory device of claim 5, wherein the current amplitude parameter and the time duration parameter associated with the first sequence of phases is communicated to a portion of the control logic associated with the second memory die.

7. The memory device of claim 1, wherein a second high current phase of the first sub-operation is executed concurrently with a low current phase of the second sub-operation.

8. A method comprising:
initiating, at a first time, a first sub-operation of a first memory access operation on a first memory die of a plurality of memory dies, wherein the first sub-operation comprises a first high current phase having a first duration;
initiating, by a processing device, a time counter at the first time;
identifying, at a second time prior to completion of the first high current phase, a request to execute a second sub-operation of a second memory access operation on a second memory die of the plurality of memory dies; and
initiating, at a third time when the time counter equals the first duration, the second sub-operation of the second memory access operation on the second memory die, wherein a total current used during concurrent execution of the first sub-operation and the second sub-operation is less than a current budget.

9. The method of claim 8, wherein the first sub-operation comprises a first sequence of phases comprising the first high current phase followed by a first low current phase.

10. The method of claim 9, wherein the second sub-operation comprises a second sequence of phases comprising an initial high current phase.

11. The method of claim 10, wherein the initial high current phase of the second sub-operation is executed concurrently with the first low current phase of the first sub-operation.

12. The method of claim 9, wherein each phase of the first sequence of phases is approximated by a rectangular waveform comprising a current amplitude parameter and a time duration parameter.

13. The method of claim 12, wherein the current amplitude parameter and the time duration parameter associated with the first sequence of phases is communicated to a portion of control logic associated with the second memory die.

14. The method of claim 8, wherein a second high current phase of the first sub-operation is executed concurrently with a low current phase of the second sub-operation.

15. A non-transitory computer-readable storage medium comprising instructions that, when executed by a processing device, cause the processing device to perform operations comprising:
initiating, at a first time, a first sub-operation of a first memory access operation on a first memory die of a plurality of memory dies, wherein the first sub-operation comprises a first high current phase having a first duration;
initiating a time counter at the first time;
identifying, at a second time prior to completion of the first high current phase, a request to execute a second sub-operation of a second memory access operation on a second memory die of the plurality of memory dies; and
initiating, at a third time when the time counter equals the first duration, the second sub-operation of the second memory access operation on the second memory die, wherein a total current used during concurrent execution of the first sub-operation and the second sub-operation is less than a current budget.

16. The non-transitory computer-readable storage medium of claim 15, wherein the first sub-operation comprises a first sequence of phases comprising the first high current phase followed by a first low current phase.

17. The non-transitory computer-readable storage medium of claim 16, wherein the second sub-operation comprises a second sequence of phases comprising an initial high current phase.

18. The non-transitory computer-readable storage medium of claim 17, wherein the initial high current phase of the second sub-operation is executed concurrently with the first low current phase of the first sub-operation.

19. The non-transitory computer-readable storage medium of claim 16, wherein each phase of the first sequence of phases is approximated by a rectangular waveform comprising a current amplitude parameter and a time duration parameter; and wherein the current amplitude parameter and the time duration parameter associated with the first sequence of phases is communicated to a portion of control logic associated with the second memory die.

20. The non-transitory computer-readable storage medium of claim 15, wherein a second high current phase of the first sub-operation is executed concurrently with a low current phase of the second sub-operation.
